(19) United States
(12) Patent Application Publication
(10) Pub. No.: US 2025/0214107 A1
(43) Pub. Date: Jul. 3, 2025

(54) METHOD FOR DEPOSITING A COATING ON A SUBSTRATE, WHICH COATING AT LEAST PARTIALLY ABSORBS VISIBLE LIGHT

(71) Applicant: The Swatch Group Research and Development Ltd, Marin (CH)

(72) Inventors: Nicolas FRANÇOIS, Neuchatel (CH); Nathalie Teres, Bale (CH)

(73) Assignee: The Swatch Group Research and Development Ltd., Marin (CH)

(21) Appl. No.: 18/941,201

(22) Filed: Nov. 8, 2024

(30) Foreign Application Priority Data
Dec. 30, 2023 (EP) 23218858.1

(51) Int. Cl. B05D 7/00; C09D 5/32; C09D 7/63; G04B 45/00

(52) U.S. Cl. CPC B05D 7/5883; C09D 5/32; C09D 7/63; G04B 45/0015

(57) ABSTRACT

A method (100) for depositing a coating on a substrate (1), which coating at least partially absorbs visible light, in order to form an item (10), such as a timepiece component.

### CROSS-REFERENCE TO RELATED APPLICATIONS

This application claims priority to European Patent Application No. 23218858.1 filed on Dec. 20, 2023, the entire contents of which are incorporated herein by reference.

### TECHNICAL FIELD OF THE INVENTION

The field of the invention relates to the surface treatment of items, such as decorative items or timepiece components.

The invention relates more particularly to a method for depositing a decorative coating which has the optical feature of absorbing visible light.

The invention further relates to an item, for example a timepiece component, coated with such a decorative coating that absorbs visible light.

The invention has a particularly interesting application in the field of watchmaking, for the decoration of items or components used in timepieces, for example plates, cocks, gear trains, screws, oscillating weights, dials, indexes, appliques, aperture discs, hands or any other component of the movement or external component of a timepiece.

### TECHNOLOGICAL BACKGROUND

Coatings that absorb visible light and have a light absorption of over 99.8% exist.

In particular, the Vantablack® coating is known, which is based on carbon nanotubes oriented perpendicularly to the surface of the substrate and pressed against each other. Such a coating gives a black colour with an absorption coefficient of 99.965% of visible light.

However, carbon nanotube-based coatings are very expensive and present health risks, as these particles are known to be carcinogenic, mutagenic or reprotoxic.

Musou® acrylic paint is also known, which is easier to use and apply, has an absorption of up to 99.4% of visible light and a lightness component L* close to 10. However, this coating has the particularity of being very fragile, and gentle contact with the coating can easily lead to peeling of the coating or a deterioration in its absorption. For example, cleaning this type of coating is very difficult without damaging its aesthetic appearance, if dust or fibres have settled thereon. Such a paint is not easily applicable, for example, in the watchmaking industry.

As a result, there is a need to improve these visible light-absorbing coatings so that they can be used on items that can be handled, for example timepiece components, without risk to health and without the risk of the coating being damaged by simple contact with or handling of the item.

### SUMMARY OF THE INVENTION

In this context, the aim of the invention is to provide an item with a coating that has at least locally high light absorption, while avoiding the use of carbon nanotubes and/or graphene particles.

To this end, the invention relates to a method for depositing a coating on a substrate, which coating at least partially absorbs visible light, in order to form an item, such as a timepiece component, said deposition method being characterised in that it comprises:
a first step of supplying a substrate;
a second step of depositing a first layer covering at least a portion of the substrate by applying a first liquid mixture comprising a binder, a solvent and pigments with a d90 percentile of nanometric dimension, the first layer being formed by evaporation of said solvent;
a third step of depositing a second layer covering a first portion of the first layer by applying a second liquid mixture comprising a binder, a solvent and pigments with a d90 percentile greater than the d90 percentile of the pigments in the first layer, the second layer being formed by evaporation of said solvent;
a fourth step of depositing a third layer covering a second portion of the first layer, which portion is different from the first portion covered by the second layer, by applying a third liquid mixture comprising a binder, a solvent and pigments with a d90 percentile greater than the d90 percentile of the pigments in the second layer, the third layer being formed by evaporation of said solvent.

According to the invention, one of the aims thereof is to propose a method for depositing a decorative coating with different levels of absorption of visible light, which deposition is easy to implement and produces decorative coatings with a lightness component L* that can be locally less than 20 with substrates of various kinds.

Preferably, the second step of depositing a second layer and/or the third step of depositing a third layer comprise a sub-step of positioning a selective mask on the first layer, before applying the corresponding liquid mixture, in order to select at least a portion of the first layer to be covered.

Preferably, the first liquid mixture forming the first layer of the coating comprises between 5 and 10% by weight of pigments.

Preferably, the second liquid mixture forming the second layer and the third liquid mixture forming the third layer respectively comprise between 4 and 10% by weight of pigments, preferably between 4 and 8%, and between 1 and 5% by weight of pigments, preferably between 1 and 4% by weight of pigments.

Preferably, the deposition method comprises a fifth step of depositing a fourth layer covering a third portion of the first layer, which portion is different from the first portion covered by the second layer and different from the second portion covered by the third layer, by applying a fourth liquid mixture comprising a binder, a solvent and pigments with a d90 percentile greater than the d90 percentile of the pigments in the third layer, the fourth layer being formed by evaporation of said solvent.

Preferably, the fourth liquid mixture forming the fourth layer comprises between 0.5 and 5% by weight of pigments, more preferably between 0.5 and 4%, and even more preferably between 0.5 and 1%.

Preferably, the various layers of the coating are deposited by sputtering, spraying, dipping, screen printing, printing or pad printing.

Preferably, the various liquid mixtures applied to form the various layers of the coating are composed of a binder, a solvent, pigments, optionally a matting agent, glass beads and/or a dispersing agent.

Preferably, the binder is a polymer.

Preferably, the binder is an acrylic, an epoxy polymer or a polyurethane.

Preferably, the various liquid mixtures applied to form the various layers of the coating are coloured inks.

The invention further relates to an item comprising a substrate and a coating applied using the method according to the invention.

Such an item thus has a light-absorbing surface coating with a lightness component L* of less than 20.

Preferably, the item is a timepiece component.

The invention further relates to a timepiece comprising such a timepiece component.

### BRIEF DESCRIPTION OF THE FIGURES

The purposes, advantages and features of the present invention will be better understood upon reading the detailed description given below with reference to the following figures:

FIG. 1 diagrammatically shows a cross-sectional view of an item, such as a timepiece component, comprising a substrate and a coating that at least partially absorbs visible light according to the invention;

FIG. 2 illustrates the main successive steps of an example implementation of a method for depositing a coating that at least partially absorbs visible light on a substrate in order to produce an item, such as a timepiece component, according to the invention;

FIG. 3 illustrates an example embodiment of an item according to the invention.

### DETAILED DESCRIPTION OF THE INVENTION

In the present description, the colorimetric properties of the light-absorbing coating obtained according to the method for depositing a coating according to the invention are expressed using the CIE L*a*b* colour space and measured according to the CIE 1976 standard on polished samples with a KONICA MINOLTA CM-3610-A spectrophotometer, with the following parameters: illumination source CIE D65 (daylight 6500° K), 10° tilt, SCI measurements (comprising specular reflection), measurement zone 4 mm in diameter.

A CIELAB colour space (in accordance with CIE standard no. 15, ISO 7724/1, DIN 5033 Teil 7, ASTM E-1164) has a lightness component L*, representative of the way in which the material reflects light, assimilated to lightness, with an a* component which is the green/red component and a b* component which is the blue/yellow component.

In the present application, the size of the particles and pigments is characterised in relation to the d90 value of a particle size distribution. In a particle size distribution, the use of the d90 percentile means that at least 90% of the particles or pigments from all of the particles used have a size below the d90 value.

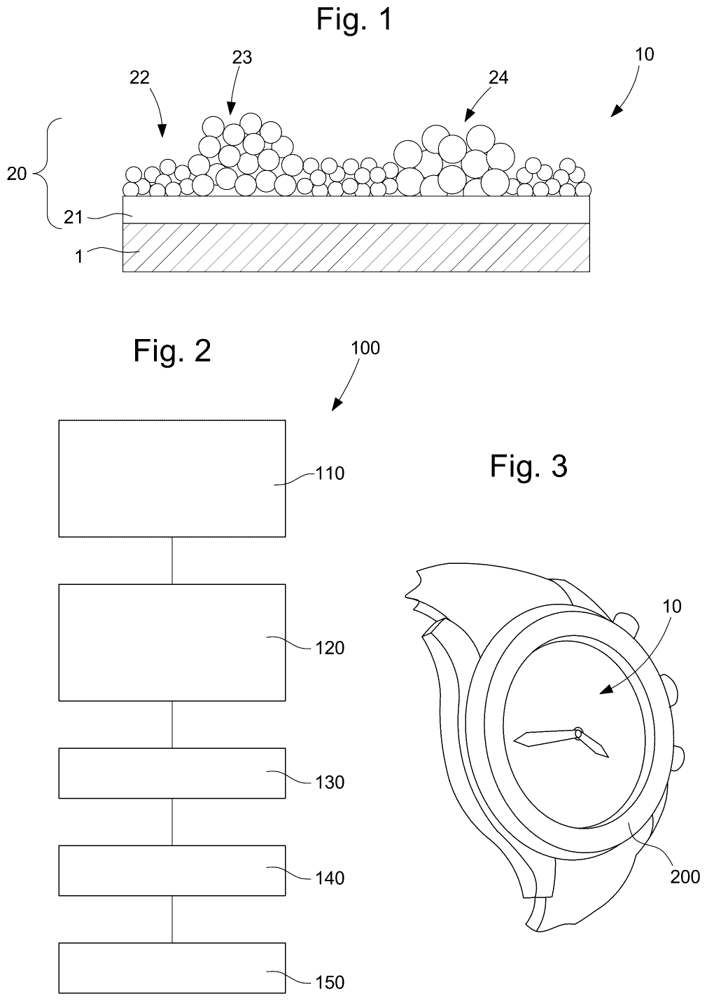

FIG. 1 diagrammatically shows a cross-sectional view of an item 10, such as a timepiece component, comprising a substrate 1 and a decorative coating 20 with visible light absorption properties.

The coating 20 covers at least a portion of the substrate 1. Such a coating 20 according to the invention forms a non-uniform structure composed of multi-zones with variable roughness, the different zones of the coating having pigments with different particle sizes.

Preferably, the density of the pigments between the various zones of the coating 20 is also variable, preferably decreasing as the size of the pigments increases.

The item 10 is, for example, a timepiece component, for example a plate, a cock, a bridge, a wheel, a screw, an oscillating weight, a dial, an index, an applique, an aperture disc, a hand or any other component or member of a horological movement or of an external component of a timepiece, that is intended to have an impression of deep and intense colour, without light reflection, with a lightness component L* of less than 20.

FIG. 3 illustrates a timepiece 200 comprising an item 10 according to the invention. In this example embodiment, the item 10 according to the invention is a dial.

The substrate 1 can be of any nature, for example it can be made of a metal, polymer, ceramic or even composite material.

The method according to the invention can be used to obtain an item 10 with a coating 20 whose lightness component L* is less than 20 with various substrates. By way of comparison, a coating method using physical vapour deposition (PVD) cannot be used to produce a coating with a lightness component L* of less than 20 because of the topology of the layers deposited. With PVD, the lightness component L* of a matt coating is between 25 and 30.

The multi-zone structure of the coating 20 according to the invention makes it possible to create patterns by varying the different levels of visible light absorption. Preferably, the multi-zone structure of the coating 20 according to the invention makes it possible to create monochrome patterns with different levels of visible light absorption.

The coating 20 comprises a first layer 21 forming a base layer, configured to cover the substrate 1, at least over a portion of the substrate 1.

Preferably, the first layer 21 completely covers at least one surface of the substrate 1.

The first layer 21 has a thickness sufficient to ensure that it is homogeneous and opaque and that the optical interference from the substrate 1 is no longer active. For example, the first layer 21 has a thickness equal to or greater than 1 μm and less than 20 μm, and more preferably a thickness of between 5 μm and 10 μm.

Preferably, the first layer 21 is formed by depositing a first liquid mixture comprising a binder, pigments and a solvent on the substrate 1.

For example, the undercoat is formed by depositing a first liquid mixture consisting of 30 to 40% by weight of binder, 50 to 60% by weight of solvent and between 5 and 10% by weight of pigments.

For example, the undercoat is formed by depositing a first liquid mixture consisting of 30% by weight of acrylic binder, 60% by weight of solvents and 10% by weight of Emperor® 1600 carbon black pigments.

Optionally, the first liquid mixture can further comprise a matting agent, for example a nanosilica, to further accentuate the intensity of the coating 20.

Optionally, the first liquid mixture can further comprise a dispersing agent to help suspend the pigments in the liquid mixture.

Preferably, the binder in the first liquid mixture forming the first layer 21 is a polymer, for example an acrylic, an epoxy polymer or a polyurethane.

For example, the first liquid mixture is a coloured ink.

For example, the first liquid mixture is a black ink containing carbon black pigments.

The first liquid mixture is applied to the substrate 1, for example, by sputtering, spraying, dipping, screen printing, printing or pad printing.

Once the first liquid mixture has been applied to the substrate 1, the solvent evaporates and the binder shrinks around the pigments, creating the first layer 21 of the coating 20.

Preferably, the pigments in the first layer 21 have a d90 percentile of nanometric dimension, for example between 20 and 120 nm, preferably less than 100 nm. Thus, the undercoat 21 is a homogeneous layer with a low roughness.

The multi-zone structure of the coating 20 is formed by a plurality of juxtaposed layers which respectively cover a defined portion of the first layer 21.

As shown in FIG. 1, the first layer 21 is covered by a second layer 22 at a first defined portion of the first layer 21. The second layer has pigments with a d90 percentile greater than the d90 percentile of the pigments in the first layer 21.

The first layer 21 is also covered by a third layer 23 at a defined second portion of the first layer 21, this second portion being different from the first portion covered by the second layer 22. This second portion may or may not be juxtaposed to the first portion.

The third layer 23 has pigments with a d90 percentile greater than the d90 percentile of the pigments in the second layer 22.

The first layer 21 can also be covered by other layers at various specific portions of the first layer 21 to create a particular pattern with particular optical features and varying levels of light absorption depending on the size of pigments used.

For the purposes of illustration, the example embodiment shown in FIG. 1 comprises a fourth layer 24 deposited locally on the first layer 21 at a defined third portion. This third portion is different from the first portion covered by the second layer 22 and from the second portion covered by the third layer 23. This third portion can be juxtaposed to the first portion and/or to the second portion. Under no circumstances are these various layers applied to the first layer 21 superimposed on one another.

The fourth layer 24 has pigments with a d90 percentile greater than the d90 percentile of the pigments in the third layer 23.

By way of example, the pigments in the layers 22, 23, 24 covering the first layer 21 have micrometric dimensions.

By way of example, the second layer 22 comprises pigments with a d90 percentile of micrometric size and less than 20 μm, for example of the order of 15 μm.

By way of example, the third layer 23 comprises pigments with a d90 percentile between 20 μm and 100 μm, preferably of the order of 80 μm.

By way of example, the fourth layer 24 comprises pigments with a d90 percentile between 100 μm and 300 μm, preferably of the order of 250 μm.

Each layer 22, 23, 24 partially covering the first layer 21 is formed respectively by depositing a liquid mixture through one or more masks applied to the first layer 21 so as to mask certain zones and reveal other zones intended to receive a layer with a predetermined particle size.

Each layer 22, 23, 24 partially covering the first layer 21 is formed respectively by depositing a liquid mixture comprising a binder, pigments and a solvent, the d90 percentile of the pigments in the different liquid mixtures varying between the various layers.

Each layer 22, 23, 24 partially covering the first layer 21 is formed respectively by depositing a liquid mixture by sputtering, spraying, dipping, screen printing, printing or pad printing.

After each mixture has been applied to the first layer 21, the solvent evaporates to allow the binder to polymerise and shrink around the pigments, thus forming the various layers with different particle sizes.

Preferably, the binder, the nature of the pigments and the solvent used to form the liquid mixtures for depositing the various layers 22, 23, 24 are identical.

Optionally, the liquid mixtures for forming the various layers of the coating 20 can comprise a matting agent, for example a nanosilica, to further accentuate the intensity of the coating 20.

Optionally, the liquid mixtures used to form the various layers of the coating 20 can comprise a dispersing agent to help suspend the pigments in the first liquid mixture.

Optionally, the liquid mixtures used to form the stack 25 can comprise glass beads to further increase the roughness of the stack.

Preferably, the binder in the liquid mixtures forming the various layers of the coating 20 is a polymer, for example an acrylic, an epoxy polymer or a polyurethane.

For example, the liquid mixtures forming the various layers of the coating 20 are coloured inks, for example black inks containing carbon black as a pigment.

Preferably, the binder, the nature of the pigments and the solvent used to form the various layers of the coating 20 are identical.

However, the pigments used to form the various layers of the coating 20 can be different in nature between the various layers and compared to the pigments used to make the first layer 21.

Preferably, the proportion of pigments in the liquid mixtures forming the various layers 22, 23, 24 deposited on the first layer 21 is between 5% and 10% by weight. Preferably, the proportion of pigments in the liquid mixture is higher the smaller the d90 percentile of the pigments.

For example, the second layer 22 is made from a liquid mixture containing between 4 and 10% by weight of pigments, preferably between 4 and 8% by weight.

For example, the third layer 23 is made from a liquid mixture containing between 1 and 5% by weight of pigments, preferably between 1 and 5%.

For example, the fourth layer 24 is made from a liquid mixture containing between 0.5 and 4% by weight of pigments, preferably between 0.5 and 1% by weight.

FIG. 2 illustrates the main steps in the method 100 for depositing a coating 20 that at least partially absorbs visible light onto a substrate 1 according to the invention.

The deposition method 100 according to the invention comprises a first step 110 of providing a substrate 1.

The deposition method 100 according to the invention comprises a second step 120 of depositing a first layer 21, referred to as the base layer, covering at least one portion of the substrate 1. This second deposition step 120 is carried out by sputtering, spraying, dipping, screen printing, printing or pad printing a first liquid mixture comprising a binder, a solvent and between 5 and 10% by weight of pigments with a d90 percentile of nanometric dimension, for example less than 100 nm.

This first step 120 of depositing a first layer 21 comprises a sub-step of evaporating the solvent from the liquid mixture applied to the substrate 1 so that the binder shrinks around the pigments to form a first layer 21 of the coating 20.

The deposition method 100 further comprises a third step 130 of depositing a second layer 22 covering a first portion of the first layer 21 previously deposited. This second layer 22 has a different particle size from the first layer 21. More particularly, this second layer 22 has pigments with a d90 percentile greater than the d90 percentile of the pigments in the first layer 21.

This second layer 22 is deposited by sputtering, spraying, dipping, screen printing, printing or pad printing a second liquid mixture comprising a binder, a solvent and between 4 and 10% by weight of pigments.

Preferably, the second liquid mixture for depositing the second layer 22 comprises between 4 and 8% by weight of pigments.

This third step 130 comprises a first sub-step of positioning a mask on the first layer 21 so as to select the zones of the first layer 21 to be covered by the second layer 22.

This third step 130 comprises a second sub-step of evaporating the solvent from the second liquid mixture applied to the first layer 21, selectively, so that the binder shrinks around the pigments to form a second layer 22 of the coating 20, on the first layer 21.

The deposition method 100 further comprises a fourth step 140 of depositing a third layer 23 covering a second portion of the first layer 21, which portion is different from the first portion selected to receive the second layer 22. This third layer 23 has a different particle size from the second layer 22. More particularly, this third layer 23 has pigments with a d90 percentile greater than the d90 percentile of the pigments in the second layer 22.

This third layer 23 is also deposited by sputtering, spraying, dipping, screen printing, printing or pad printing a third liquid comprising a binder, a solvent and between 1 and 5% by weight of pigments.

Preferably, the third liquid mixture for depositing the third layer 23 comprises between 1 and 4% by weight of pigments.

This fourth step 140 comprises a first sub-step of positioning a mask on the first layer 21 so as to select the zones of the first layer 21 to be covered by the third layer 23.

This fourth step 140 comprises a second sub-step of evaporating the solvent from the third liquid mixture applied to the first layer 21, selectively, so that the binder shrinks around the pigments to form a third layer 23 of the coating 20, on the first layer 21.

As illustrated by way of example, the deposition method 100 can further comprise a fifth step 140 of depositing a fourth layer 24 covering a third portion of the first layer 21, which portion is different from the portions previously selected to receive the second layer 22 and the third layer 23. This fourth layer 24 has a different particle size from the third layer 23. More particularly, this fourth layer 24 has pigments with a d90 percentile greater than the d90 percentile of the pigments in the third layer 22.

This fourth layer 24 is also deposited by sputtering, spraying, dipping, screen printing, printing or pad printing a fourth liquid comprising a binder, a solvent and between 0.5 and 5% by weight of pigments.

Preferably, the fourth liquid mixture for depositing the fourth layer 24 comprises between 0.5 and 4% by weight of pigments.

This fifth step 150 comprises a first sub-step of positioning a mask on the first layer 21 so as to select the zones of the first layer 21 to be covered by the fourth layer 24.

This fifth step 150 comprises a second sub-step of evaporating the solvent from the fourth liquid mixture applied to the first layer 21, selectively, so that the binder shrinks around the pigments to form a fourth layer 24 of the coating 20, on the first layer 21.

It goes without saying that the deposition method 100 can comprise other steps for depositing additional layers depending on the desired patterns and properties of the coating 20.

According to a first example embodiment of the invention, a brass substrate is used, for example to form a dial, to which a light-absorbing coating according to the invention is applied.

The brass substrate is, for example, 0.27 mm thick.

The first layer 21 is applied to the brass substrate by dipping in a first liquid mixture consisting of 2 g of polyurethane resin (Berlacryl), 0.5 g of Emperor 1600 carbon black pigments and 2.8 g of Berlaflex thinner. The layer is left to dry for 20 minutes to allow the thinner to evaporate.

The second layer 22 is applied to the first layer 21 through a first selective mask by dipping in a second liquid mixture consisting of 2 g of polyurethane resin (Berlacryl), 0.3 g of Living Ink pigments and 3.5 g of Berlaflex thinner. The layer is left to dry for 20 minutes to allow the thinner to evaporate.

The third layer 23 is applied to the first layer 21 through a second selective mask by dipping in a third liquid mixture consisting of 2 g of polyurethane resin (Berlacryl), 0.2 g of Norit A ultra E153 pigments and 4 g of Berlaflex thinner. The layer is left to dry for 20 minutes to allow the thinner to evaporate.

The fourth layer 24 is applied to the first layer 21 through a third selective mask by dipping in a fourth liquid mixture consisting of 2 g of polyurethane resin (Berlacryl), 0.2 g of Norit SX super E153 carbon pigments, 1.5 g of 90-150 μm glass beads and 4 g of Berlaflex thinner. The layer is left to dry for 20 minutes to allow the thinner to evaporate.

Such a coating produces a brass dial with a black surface coating and a lightness component L* of 16.

1. A method for depositing a coating on a substrate, which coating at least partially absorbs visible light, in order to form an item, such as a timepiece component, wherein said deposition method comprises:
a first step of supplying a substrate;
a second step of depositing a first layer covering at least a portion of the substrate by applying a first liquid mixture comprising a binder, a solvent and pigments with a d90 percentile of nanometric dimension, the first layer being formed by evaporation of said solvent;
a third step of depositing a second layer covering a first portion of the first layer by applying a second liquid mixture comprising a binder, a solvent and pigments with a d90 percentile greater than the d90 percentile of the pigments in the first layer, the second layer being formed by evaporation of said solvent;
a fourth step of depositing a third layer covering a second portion of the first layer, which portion is different from the first portion covered by the second layer, by applying a third liquid mixture comprising a binder, a solvent and pigments with a d90 percentile greater than the d90 percentile of the pigments in the second layer, the third layer being formed by evaporation of said solvent.

2. The method for depositing a coating on a substrate according to claim 1, wherein the second step of depositing a second layer and/or the third step of depositing a third layer comprise a sub-step of positioning a selective mask on the first layer, before applying the corresponding liquid mixture, in order to select at least a portion of the first layer to be covered.

3. The method for depositing a coating on a substrate according to claim 1, wherein the first liquid mixture forming the first layer of the coating comprises between 5 and 10% by weight of pigments.

4. The method for depositing a coating on a substrate according to claim 1, wherein the second liquid mixture forming the second layer comprises between 4 and 10% by weight of pigments.

5. The method for depositing a coating on a substrate according to claim 1, wherein the third liquid mixture forming the third layer comprises between 1 and 5% by weight of pigments.

6. The method for depositing a coating on a substrate according to claim 1, wherein the deposition method comprises a fifth step of depositing a fourth layer covering a third portion of the first layer, which portion is different from the first portion covered by the second layer and different from the second portion covered by the third layer, by applying a fourth liquid mixture comprising a binder, a solvent and pigments with a d90 percentile greater than the d90 percentile of the pigments in the third layer, the fourth layer being formed by evaporation of said solvent.

7. The method for depositing a coating on a substrate according to claim 6, wherein the fourth liquid mixture forming the fourth layer comprises between 0.5 and 5% by weight of pigments.

8. The method for depositing a coating on a substrate according to claim 1, wherein the various layers of the coating are deposited by sputtering, spraying, dipping, screen printing, printing or pad printing.

9. The method for depositing a coating on a substrate according to claim 1, wherein the various liquid mixtures applied to form the various layers of the coating are composed of a binder, a solvent, pigments, optionally a matting agent, glass beads and/or a dispersing agent.

10. The method for depositing a coating on a substrate according to claim 9, wherein the binder is a polymer.

11. The method for depositing a coating on a substrate according to claim 10, wherein the binder is an acrylic, an epoxy polymer or a polyurethane.

12. The method for depositing a coating on a substrate according to claim 1, wherein the various liquid mixtures applied to form the various layers of the coating are coloured inks.

13. Item comprising a substrate and a coating that at least partially absorbs visible light, deposited by the deposition method according to claim 1, the coating having a lightness component L* less than 20.

14. An item according to claim 13, wherein the item is a timepiece component.

15. A timepiece comprising a component comprising a substrate and a coating that at least partially absorbs visible light, deposited by the deposition method according to claim 1, the coating having a lightness component L* less than 20.
